(19) United States
(12) Patent Application Publication
(10) Pub. No.: US 2026/0216602 A1
(43) Pub. Date: Jul. 30, 2026

(54) INFORMATION PROCESSING METHOD, ELECTRONIC DEVICE, AND STORAGE MEDIUM

(71) Applicant: NETEASE (HANGZHOU) NETWORK CO., LTD., Hangzhou, Zhejiang (CN)

(72) Inventors: Yunpeng LI, Hangzhou, Zhejiang (CN); Yujie LI, Hangzhou, Zhejiang (CN)

(73) Assignee: NETEASE (HANGZHOU) NETWORK CO., LTD., Hangzhou, Zhejiang (CN)

(21) Appl. No.: 19/147,398

(22) PCT Filed: May 29, 2023
(86) PCT No.: PCT/CN2023/096934

§ 371 Date: Jul. 11, 2025

(30) Foreign Application Priority Data
Jan. 15, 2023 (CN) 202310095326.6

(51) Int. Cl. A63F 13/56; A63F 13/52; A63F 13/533; A63F 13/5372; A63F 13/577

(52) U.S. Cl. CPC A63F 13/56; A63F 13/52; A63F 13/533; A63F 13/5372; A63F 13/577

(57) ABSTRACT

An information processing method, comprising: displaying at least one other virtual character (S110); determining a target virtual character from the other virtual character (S130); displaying at least one available hit position on the target virtual character (S150); determining a target hit position from the available hit position (S170); and controlling a master control virtual character to strike the target virtual character and triggering a hit effect corresponding to the target hit position (S190). The method can at least partially solve the technical problems in the related technical solution of difficulty in aiming of a striking position, low accuracy of striking position selection, etc.

### CROSS REFERENCE TO RELATED APPLICATIONS

The present application is a U.S. National Stage of International Application No. PCT/CN2023/096934, filed on May 29, 2023, which claims the priority of the Chinese patent application with an application No. 202310095326.6 filed on Jan. 15, 2023 and entitled by “INFORMATION PROCESSING METHOD, ELECTRONIC DEVICE, AND STORAGE MEDIUM”, the entire contents of both of which are incorporated herein by reference for all purposes.

### TECHNICAL FIELD

The present disclosure relates to the field of computers, and in particular, to an information processing method, an electronic device, and a storage medium.

### BACKGROUND

In some games, game players can manipulate their own virtual characters to strike enemy virtual characters. In certain situations or certain types of games, different hit effects can be obtained by striking different positions of the enemy virtual character.

In the related art, there is a solution for adjusting strikes on different positions of the enemy virtual character as follows: a crosshair is displayed in the game interface, and the game player can control the position of the crosshair through manipulation, so as to aim at the desired position for striking the enemy virtual character by changing the position of the crosshair.

### SUMMARY

According to one aspect of the present disclosure, there is provided an information processing method, which includes: displaying at least one other virtual character; determining a target virtual character from the other virtual character; displaying at least one available hit position on the target virtual character; determining a target hit position from the available hit position; and controlling a master control virtual character to strike the target virtual character and triggering a hit effect corresponding to the target hit position.

According to one aspect of the present disclosure, an electronic device is further provided, including: a processor; and a memory for storing executable instructions of the processor; where the processor is configured to execute the following method by executing the executable instructions: displaying at least one other virtual character; determining a target virtual character from the other virtual character; displaying at least one available hit position on the target virtual character; determining a target hit position from the available hit position; and controlling a master control virtual character to strike the target virtual character and triggering a hit effect corresponding to the target hit position.

According to one aspect of the present disclosure, a computer-readable storage medium is further provided, on which a computer program is stored. The computer program, when executed by a processor, implements the following method: displaying at least one other virtual character; determining a target virtual character from the other virtual character; displaying at least one available hit position on the target virtual character; determining a target hit position from the available hit position; and controlling a master control virtual character to strike the target virtual character and triggering a hit effect corresponding to the target hit position.

### BRIEF DESCRIPTION OF THE DRAWINGS

FIG. 1 is a schematic flow chart of an information processing method according to an embodiment of the present disclosure;

FIG. 2 is a schematic diagram of an information processing method according to an embodiment of the present disclosure;

FIG. 3 is another schematic diagram of an information processing method according to an embodiment of the present disclosure; and

FIG. 4 is a schematic block diagram of an electronic device according to an embodiment of the present disclosure.

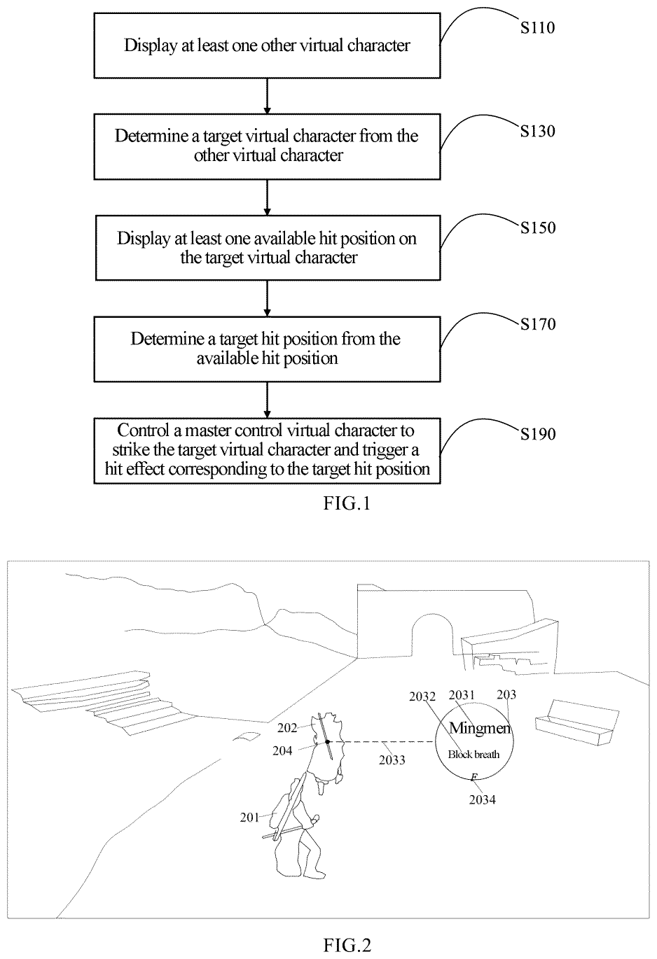

### DETAILED DESCRIPTION

In order to make those skilled in the art better understand the solutions of the present disclosure, the technical solutions in the embodiments of the present disclosure will be clearly and completely described below with reference to the drawings in the embodiments of the present disclosure. It is apparent that the described embodiments are only a part of the embodiments of the present disclosure, not all of the embodiments. On the basis of the embodiments of the present disclosure, all other embodiments obtained by those of ordinary skill in the art without creative efforts should fall within the scope of protection of the present disclosure.

It is to be noted that the terms “first”, “second” and the like in the specification and claims of the present disclosure and the above drawings are used to distinguish similar objects, rather than necessarily used to describe a specific sequence or a precedence order. It may be appreciated that data used in such a way may be exchanged under appropriate conditions, so that that the embodiments of the present disclosure described herein can be implemented in an order other than those illustrated or described herein. In addition, terms “include” and “have” and any variations thereof are intended to cover non-exclusive inclusions. For example, processes, methods, systems, products or devices that contain a series of steps or units are not necessarily limited to those steps or units clearly limited, but may include other steps or units which are not clearly listed or inherent to these processes, methods, products or devices.

It should be noted that the steps shown in the flowcharts of the accompanying drawings may be executed in a computer system such as a set of computer executable instructions, and that, although a logical order is shown in the flowcharts, in some cases, the steps shown or described can be executed in an order different from that shown herein.

According to an information processing method according to an embodiment of the present disclosure, the method may include the following steps.

In step S110, at least one other virtual character is displayed.

In step S130, a target virtual character is determined from other virtual character.

In step S150, at least one available hit position on the target virtual character is displayed.

In step S170, a target hit position is determined from the available hit position.

In step S190, the master control virtual character is controlled to strike the target virtual character and a hit effect corresponding to the target hit position is triggered.

Through the information processing method in this embodiment, at least one other virtual character is displayed; a target virtual character is determined from other virtual characters; at least one available hit position on the target virtual character is displayed; a target hit position is determined from the available hit position; and the master control virtual character is controlled to strike the target virtual character and the hit effect corresponding to the target hit position is triggered. In this way, the technical problems in the solutions of related art, such as the difficulty in aiming at the hit position and the low accuracy of selecting the hit position, can be at least partially solved, and the user can more conveniently determine the hit position and improve the accuracy of selecting the hit position.

In some games, gamers can manipulate their own virtual characters to strike the enemy virtual characters. In certain scenarios or certain types of games, striking different positions of the enemy virtual character can obtain different hit effects.

In the related art, there is a solution for adjusting strikes on different positions of the enemy virtual character as follows: a crosshair is displayed in the game interface, and gamers can control the position of the crosshair through manipulation, so as to aim at the desired position to strike the enemy virtual character by changing the position of the crosshair.

During the long-term research and development process, the applicant of this application discovered that in the above-mentioned solution and other related technologies, there may be technical problems such as difficulty in aiming the hit position and low accuracy in selecting the hit position.

Next, the information processing method in this embodiment will be further described.

In step S110, at least one other virtual character is displayed.

In an optional embodiment, as shown in the schematic diagram of a graphical user interface in FIG. 2, a master control virtual character 201 is displayed in the graphical user interface, and another virtual character 202 is also displayed in the graphical user interface.

The master control virtual character 201, namely “my” virtual character (usually also referred to as “I” in the virtual scene), is a virtual character controlled by the operating device corresponding to the graphical user interface.

The master control virtual character 201 may be fully displayed in the graphical user interface, partially displayed in the graphical user interface, or not displayed in the graphical user interface, which is usually determined according to the type of game or the user's settings.

The graphical user interface may display one other virtual character 202, or more other virtual characters, such as two other virtual characters or more than two other virtual characters. The other virtual characters and the master control virtual character may be in the same camp or in different camps; the other virtual characters may be virtual characters controlled by other users (players), or virtual characters controlled by the system (e.g., non-player characters in the game).

In the step S130, the target virtual character is determined from other virtual characters.

For the determination of the target virtual character from the other virtual characters, it may be determined according to the user's operation or automatically determined by the system.

In an optional embodiment, determining the target virtual character from other virtual characters includes: adjusting the position of the crosshair in response to an adjustment operation on the crosshair; and determining the target virtual character from other virtual characters according to the position of the crosshair. In this way, the user can select the virtual character that is expected to be hit by adjusting the crosshair, and then further accurately select the specific position of the virtual character that is expected to be hit through the subsequent method steps in this embodiment, thereby realizing the combination of “rough selection (selecting the character)” and “fine selection (selecting the position)”, which not only reduces the difficulty of operation, but also improves the precision of selection.

When there are more than or equal to two other virtual characters displayed in the graphical user interface, the user can adjust the position of the crosshair in the graphical user interface through input devices such as a keyboard or mouse of a personal computer, a joystick on a game console controller, a touch screen of a mobile phone or tablet computer, etc., and determine the target virtual character from other virtual characters in the virtual environment based on the adjusted crosshair.

The position of the crosshair in the graphical user interface is adjusted through input devices such as a keyboard or mouse of a personal computer, a joystick on a game console controller, a touch screen of a mobile phone or tablet computer, etc., which will not be repeated here.

In some embodiments, when the crosshair approaches other virtual characters, an adsorption effect may be generated to reduce the difficulty of determining the target virtual character through the crosshair. In some embodiments, after the crosshair is adsorbed to the other virtual character, the virtual lens corresponding to the graphical user interface may follow the other virtual character to move within a small range, and the significant movement of the other virtual character or the user's manual adjustment on the virtual lens may lead to the cancellation of adsorption. The user may adjust the angle and/or position of the virtual lens through input devices such as the keyboard or mouse of a personal computer, the joystick on the game console controller, the touch screen of a mobile phone or tablet, etc.

The virtual lens is also referred to as a virtual camera. By capturing shots in the virtual scene through the virtual camera, virtual images for being displayed in the graphical user interface can be obtained. The virtual images typically include the captured virtual environment and virtual characters. The virtual camera has a set shooting angle and shooting position in the virtual scene. In some games, the user may independently adjust the shooting angle and shooting position of the virtual camera through input devices.

In an optional embodiment, determining the target virtual character from other virtual characters includes: the system automatically determining the target virtual character from other virtual characters. In this way, the target virtual character is automatically determined for the user through system preset rules or system artificial intelligence, the user's control difficulty can be reduced, and the operation steps for the user to select the hit position are saved, so that the user can focus more on the selection control of the specific hit position, which helps to improve the accuracy of the selection of the hit position.

For example, in the situation shown in FIG. 2, the other virtual character 202 has its back to the master control virtual character 201. The other virtual character 202 is a virtual character of the enemy camp, and the other virtual character 202 does not detect that the master control virtual character 201 is approaching. In this case, the system preset rules or system artificial intelligence can help the user automatically determine the other virtual character 202 as the target virtual character. In some embodiments, the name 2031 of the available hit position of the target virtual character (other virtual character 202) may be displayed in the interface. In some embodiments, the hit effect 2032 of the available hit position of the target virtual character (other virtual character 202) may be displayed in the interface. In some embodiments, the key for selection 2034 of the available hit position of the target virtual character (other virtual character 202) may be displayed in the interface. In some embodiments, the available hit position 204 of the target virtual character (other virtual character 202) may be automatically displayed on the model of the character. In some embodiments, the name or effect of the available hit position on the model of the target virtual character (other virtual character 202) may be connected with the name or effect of the available hit position of the target virtual character via an auxiliary line 2033.

In the step S150, at least one available hit position on the target virtual character is displayed.

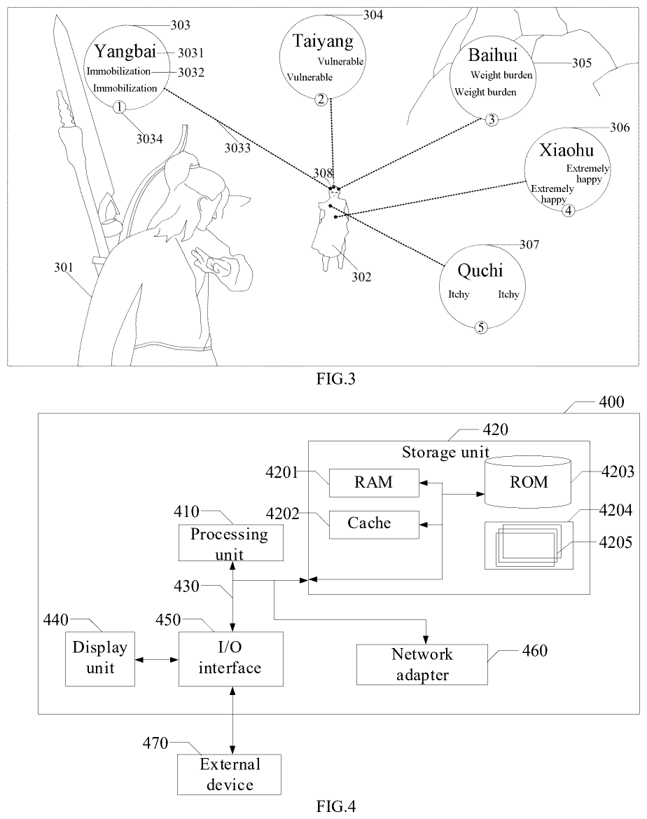

One available hit position on the target virtual character may be displayed, such as one available hit position as shown in FIG. 2; alternatively, two or more available hit positions on the target virtual character may also be displayed, such as five available hit positions as shown in FIG. 3.

In an optional embodiment, displaying at least one available hit position on the target virtual character includes: marking at least one available hit position on the model of the target virtual character. In this way, by marking the available hit position on the model of the target virtual character, the user can intuitively feel the specific position of the available hit position on the character, providing a clear position indication for the subsequent selection steps. Furthermore, for some experienced players that do not need excessive additional prompts, by marking the available hit position on the model of the target virtual character, these experienced players can know the hit effect corresponding to the specific available hit position and the corresponding selection triggering method, thereby improving the utilization efficiency of the screen display.

For example, as shown in FIG. 3, five available hit positions including the available hit position 305 are marked on the character model of the other virtual character 302. Further, among the five available hit positions, three are located at the head of the other virtual character 302, and two are located at the torso of the other virtual character 302. For some skilled players, they may be proficient enough to recall and associate the name of a certain available hit position (e.g., Yangbai 3031), the hit effect (e.g., Immobilization 3032), and the selection triggering method (key position) (e.g., number “1” key 3034) according to the specific position of the available hit position in the other virtual character 302.

In an optional embodiment, displaying at least one available hit position on the target virtual character includes: displaying at least one piece of descriptive information for at least one available hit position of the target virtual character, where the descriptive information includes description content for the available hit position. In this way, by displaying corresponding descriptive information for the available hit position, more complete and clearer prompt information can be provided to the user, especially for some novice players, to help the player select the desired available hit position more accurately and quickly.

In some embodiments, the description content of the descriptive information may be the name of an available hit position (e.g., YangBai 3031) and/or the hit effect (e.g., Immobilization 3032).

In an optional embodiment, the descriptive information includes an auxiliary line 3033 for the available hit position, where the auxiliary line connects the descriptive information 303 and the available hit position 308 on the target virtual character. In this way, the correlation between the descriptive information of the available hit position and the specific position of the available hit position on the character model can be enhanced, which helps the player to establish and strengthen the mapping relationship between the two in memory, thereby improving the operation consistency and accuracy in the later game operation.

In an optional embodiment, the available hit position is determined according to the orientation of the target virtual character relative to the master control virtual character. In this way, different available hit positions can be provided according to the orientation of the target virtual character relative to the master control virtual character, thereby enabling more targeted provision and display of the available hit positions. This reduces interference from excessive unnecessary or irrelevant available hit positions on user operations, improves the speed of selection operations, and can further enhance the accuracy of hit position selection.

For example, when the target virtual character has its back to the master control virtual character, the available hit position on the back of the target virtual character (for example, the available hit position “Mingmen” 204 on the back of the torso of the target virtual character as shown in FIG. 2) may be displayed. When the target virtual character is facing the master control virtual character, the available hit position on the front of the target virtual character (for example, the available hit position “Xiaohu” on the front of the torso of the target virtual character as shown in FIG. 3) may be displayed.

In an optional embodiment, the available hit position is determined according to the type of the target virtual character. In this way, different available hit positions can be provided according to the different types of the target virtual characters, thereby enabling more targeted provision and display of the available hit positions. This reduces the interference from excessive unnecessary and irrelevant available hit positions on user operations, and improves the speed and accuracy of selection operations.

For example, in some games, different types of non-player characters are provided, and different types of non-player characters are configured with different functions or tasks. Different available hit positions can be provided according to the types of non-player characters. For some non-player characters with single functions or specific tasks, a smaller number of available hit positions may be configured, and for some non-player characters with composite functions or complex tasks, a larger number of available hit positions may be configured.

In the step S170, the target hit position is determined from the available hit position.

In an optional embodiment, determining the target hit position from the available hit position includes: determining the target hit position from the available hit position according to the received target key instruction, where a mapping relationship exists between the target key corresponding to the target key instruction and the target hit position, where the target key instruction is generated according to the target key. In this way, it is convenient for the user to quickly select the target hit position using an input device such as a keyboard, a mouse, or a handle according to the indication information displayed on the graphical user interface.

For example, as shown in FIG. 3, the descriptive information 303 includes key information 3034 for selecting the available hit position corresponding to the descriptive information. FIG. 3 shows five available hit positions, each of which corresponds to its own descriptive information, and each piece of descriptive information includes different key information for selection, and there is a mapping relationship between these key information and the available hit positions. The five different key information in FIG. 3 are number key 1, number key 2, number key 3, number key 4, and number key 5. In some embodiments, the key information here may be number keys, letter keys or other symbol keys on the keyboard, etc.; the left button, middle button or right button on the mouse, etc.; various buttons on the game controller; or other distinguishable physical buttons or virtual buttons.

In an optional embodiment, determining the target hit position from the available hit position includes: determining the target hit position from the available hit position according to a selection operation on the available hit position acting on the graphical user interface. In some embodiments, the selection operation on the available hit position acting on the graphical user interface may be a selection operation on the available hit position, or a selection operation on the descriptive information corresponding to the available hit position. In this way, it is convenient for the user to directly and intuitively select the available hit position or the corresponding descriptive information, reduce the reading and mapping understanding of the prompt information, and improve the speed and accuracy of the hit position selection operation.

For example, the user may control the cursor with the mouse to click on the description corresponding to the available hit position to achieve the purpose of selecting the corresponding available hit position; or the user may tap the description corresponding to the available hit position with a finger to achieve the purpose of selecting the corresponding available hit position. Alternatively, the user may control the cursor with the mouse to click on the available hit position on the character model to achieve the purpose of selecting the corresponding available hit position; or the user may touch and click on the available hit position on the character model with a finger to achieve the purpose of selecting the corresponding available hit position. In some embodiments, in addition to selecting through the above-mentioned clicking methods, the available hit position may also be selected by other operations containing directional information such as dragging, sliding, and double-clicking. Specifically, the available hit position may be selected through the starting position, ending position, or trajectory of the dragging or sliding operation, and the desired available hit position may also be determined through the initial click position, ending click position, or click positions of the double-click.

In an optional embodiment, the information processing method includes: highlighting the target descriptive information corresponding to the target hit position to distinguish the target descriptive information from the descriptive information corresponding to other available hit position. Further, the information processing method includes: retaining the display of the target descriptive information and canceling the display of the descriptive information corresponding to other available hit position. In this way, good selection feedback can be provided to the user.

For example, FIG. 3 shows five available hit positions. If the user selects the available hit position “Baihui”, the descriptive information corresponding to the available hit position “Baihui” may be highlighted to prompt the user that the available hit position “Baihui” has been selected. Specifically, the color of the name “Baihui” corresponding to the available hit position may be switched from white to green. In some embodiments, part or all of the target descriptive information (the descriptive information corresponding to the target hit position) may have its display parameters such as color, size, font or transparency changed to achieve the purpose of distinguishing it from other unselected descriptive information. In some embodiments, the display content (prompt information) may be increased or decreased for the target descriptive information to achieve the purpose of distinguishing it from other unselected descriptive information. In some embodiments, the target descriptive information may remain displayed and the display of the descriptive information corresponding to other available hit position may be cancelled. In some embodiments, the target descriptive information retained in display may also be cancelled after a predetermined time, or the target descriptive information retained in display may be cancelled after the master control virtual character completes the strike on the target hit position.

In an optional embodiment, the types of available hit position include a first-type position and a second-type position; controlling the master control virtual character to strike the target virtual character includes: controlling the master control virtual character to strike the target hit position of the target virtual character; if the target hit position is the first-type position, then after the target hit position is struck, identifying the target hit position as the second-type position; if the target hit position is the second-type position, then after the target hit position is struck, identifying the target hit position as the first-type position. In some embodiments, the display parameters of the descriptive information corresponding to the available hit position of the first-type position type and those corresponding to the available hit position of the second-type position type are different. In this way, the user can easily obtain the type information of the available hit position through the descriptive information with different display parameters, so as to quickly filter the desired available hit position. The display parameters here include but are not limited to size, color, transparency and other parameters that are convenient for distinguishing the descriptive information.

For example, in an embodiment, the descriptive information of six available hit positions may be displayed in the graphical user interface, where one piece of descriptive information is in green and the other five pieces of descriptive information are in white. In some embodiments, the first-type position may be represented by the green descriptive information; the second-type position may be represented by the white descriptive information. In some embodiments, the first-type position is the available hit position corresponding to the descriptive information that has been struck before, has been struck within a predetermined time period in the past, or has been struck and the hit effect is still continuing, and the second-type position is the available hit position corresponding to the descriptive information that has not been struck before, has not been struck within a predetermined time period in the past, or has been struck but the hit effect has ended. Alternatively, the second-type position is the available hit position corresponding to the descriptive information that has been struck before, has been struck within a predetermined time period in the past, or has been struck and the hit effect is still continuing, and the first-type position is the available hit position corresponding to the descriptive information that has not been struck before, has not been struck within a predetermined time period in the past, or has been struck but the hit effect has ended.

In an optional embodiment, the target virtual character includes a first part and a second part, and the at least one available hit position includes a first available hit position located at the first part and a second available hit position located at the second part. In this way, the precision of hit position selection can be further improved.

In an optional embodiment, the target virtual character is a virtual human. In some embodiments, the first part is the head and the second part is the torso, or the first part is the torso and the second part is the head.

For example, the head of the virtual character includes two or more available hit positions, and the torso of the virtual character includes two or more available hit positions, and different available hit positions correspond to different hit effects.

In an optional embodiment, the game system configures available hit position parameters for other virtual characters, and the available hit position parameters are used to indicate the available hit positions of other virtual characters. For example, three available hit positions may be configured for the head of a certain other virtual character, two available hit positions may be configured for the front of the torso, and one available hit position can be configured for the back of the torso.

In an optional embodiment, the user may trigger entering the available hit position selection state through a specific operation instruction. In the available hit position selection state, the user may adjust the position of the crosshair through the crosshair adjustment instruction to select the target virtual character to be struck in the graphical user interface. Further, in some embodiments, the available hit position parameters of the target virtual character pre-configured by the system may be read, and the corresponding available hit position or the descriptive information of the available hit position may be displayed according to these available hit position parameters.

In an optional embodiment, the game system may automatically trigger entry into the available hit position selection state. For example, when there are other virtual characters that meet the system preset rules or system artificial intelligence judgment conditions within the viewing range of the master control virtual character, the game system may automatically trigger entry into the available hit position selection state, and automatically confirm the other virtual character as the target virtual character. In some embodiments, when the game system automatically triggers entry into the available hit position selection state, the user may adjust the position of the crosshairs through the crosshairs adjustment instruction to select the target virtual character to be struck in the graphical user interface. Further, in some embodiments, the available hit position parameters of the target virtual character pre-configured by the system may be read, and the corresponding available hit position or the descriptive information of the available hit position may be displayed according to these available hit position parameters. In some embodiments, when the game system automatically triggers entry into the available hit position selection state, the target virtual character may be automatically determined. Further, in some embodiments, the available hit position parameters of the target virtual character pre-configured by the system may be read, and the corresponding available hit position or the descriptive information of the available hit position may be displayed according to these available hit position parameters.

In the step S190, the master control virtual character is controlled to strike the target virtual character and a hit effect corresponding to the target hit position is triggered.

In an optional embodiment, the hit effect may be one or more of the following: increase or decrease in health value, change in the step size of increase or decrease in health value, increase or decrease in movement speed, increase or decrease in attack ability, change or recovery of expression or emotion, etc. The increase or decrease amplitude (or value) may be an amplitude (or value) determined according to system rules or system artificial intelligence, or it may be directly increased or decreased to a maximum value or a minimum value. In some embodiments, change in the step size of increase or decrease in health value refers to whether the character may more easily increase health value after receiving other assistance, or whether the character may more easily reduce health value after being subjected to other strikes, when the character is in the state under this hit effect. For example, in the state under this hit effect, the character is more likely to increase health value, or the character is more likely to reduce health value after subjected to other strikes. Specifically, taking the hit effect of clicking acupoints in the game as an example, the struck character may be “immobilized”, that is, the moving speed is reduced or it is immobile; or, the struck character may be “defeated”, that is, the health value is reduced or returned to zero; or, the struck character may be “extremely happy”, that is, laughing wildly and unable to strike the master control virtual character; or, the struck character may be “vulnerable”, that is, in the state of the hit effect, subsequent strikes are more likely to cause damage to the character, etc. On the contrary, it may also enable the “immobilized” virtual character to regain the ability to move; or, it may also enable the virtual character in the “extremely happy” state to return to a normal expression and restore strike ability, etc.

In an optional embodiment, the strike is a contact strike or a non-contact strike.

For example, a contact strike refers to a strike made by the limbs or melee weapons of the master control virtual character that makes contact with the target virtual character; a non-contact strike refers to a strike made by the limbs or melee weapons of the master control virtual character that makes no contact with the target virtual character. For example, a contact strike includes virtual actions such as tapping, poking, and hitting the target virtual character using body parts like fingers, fists, elbows and other, etc.; a non-contact strike includes virtual actions such as attacking the target virtual character from a distance using spells, stones, sword energy, etc.

In an optional embodiment, controlling the master control virtual character to strike the target virtual character and triggering the hit effect corresponding to the target hit position includes: controlling the master control virtual character to strike the target hit position of the target virtual character and triggering the hit effect corresponding to the target hit position.

The master control virtual character may be controlled to strike the target virtual character's target hit position through contact or non-contact manner. For example, the master control virtual character may be automatically controlled to move closer to the target virtual character to facilitate strikes on the target hit position through contact, and in some embodiments, the moving trajectory of the master control virtual character moving closer to the target virtual character may be displayed. For example, the master control virtual character may strike the target hit position without contact using spells, stones, sword energy, etc., and in some embodiments, the striking line (trajectory) of the spells, stones, and sword energy may be displayed. Further, the visual representation of the strike to the target hit position may be displayed, such as highlighting the target hit position, etc.

In an optional embodiment, the information processing method includes: displaying an action connection line of the master control virtual character striking the target hit position, where the action connection line connects the master control virtual character and the target hit position.

In an optional embodiment, in response to displaying the action connection line, the display of the descriptive information corresponding to the target hit position is canceled.

The information processing method of the present disclosure can be used in scenarios such as mobile games, PC games, console games, and cloud games.

In an embodiment of the present disclosure, an electronic device capable of implementing the above method is further provided.

Those skilled in the art can understand that various aspects of the present disclosure may be implemented as a system, method or program product. Therefore, various aspects of the present disclosure may be embodied in the following forms, namely: a complete hardware implementation, a complete software implementation (including firmware, microcode, etc.), or a combination of hardware and software implementations, which may be collectively referred to herein as “circuit”, “module”, or “system”.

An electronic device 400 according to an embodiment of the present disclosure is described below with reference to FIG. 4. The electronic device 400 shown in FIG. 4 is only an example, and should not limit the functions and scope of use of embodiments of the present disclosure.

As shown in FIG. 4, the electronic device 400 takes the form of general-purpose computing device. The components of the electronic device 400 may include, but are not limited to: at least one processing unit 410 described above, at least one storage unit 420 described above, a bus 430 connecting different system components (including the storage unit 420 and the processing unit 410), and a display unit 440.

The storage unit stores program codes, and the program codes may be executed by the processing unit 410, so that the processing unit 410 executes the steps according to various embodiments of the present disclosure described above in this specification. The storage unit 420 may include a readable medium in the form of volatile storage unit, such as a random access storage unit (RAM) 4201 and/or a cache storage unit 4202, and may further include a read-only storage unit (ROM) 4203.

The storage unit 420 may also include a program or utility 4204 having a set of (at least one) program modules 4205. Such program modules 4205 including but not limited to: an operation system, one or more application programs, other program modules, and program data. Implementations of the networked environments may be included in each or some combination of these examples.

The bus 430 may represent one or more of several types of bus structures, including a storage unit bus or storage unit controller, a peripheral bus, a graphics acceleration port, a processing unit, or a local bus using any of a variety of bus structures.

The electronic device 400 may also communicate with one or more external devices 470 (such as keyboards, pointing devices, Bluetooth devices, etc.), and may also communicate with one or more devices that enable the user to interact with the electronic device 400, and/or communicate with any device (e.g., router, modem, etc.) that enables the electronic device 400 to communicate with one or more other computing devices. Such communication may be performed through the input/output (I/O) interface 450. Moreover, the electronic device 400 may also communicate with one or more networks (such as a local area network (LAN), a wide area network (WAN), and/or a public network such as the Internet) through the network adapter 460. As shown, the network adapter 460 communicates with other modules of the electronic device 400 through the bus 430. It should be appreciated that although not shown, other hardware and/or software modules may be used in conjunction with the electronic device 400, including but not limited to: microcodes, device drivers, redundant processing units, external disk drive arrays, RAID systems, tape drives, and data backup storage system, etc.

Through the description of the above implementations, those skilled in the art can easily understand that the example implementations described here may be implemented by software, or by a combination of software and necessary hardware. Therefore, the technical solutions according to embodiments of the present disclosure may be embodied in the form of software products, and the software products may be stored in a non-volatile storage medium (which may be CD-ROM, U disk, mobile hard disk, etc.) or on the network, including several instructions to enable a computing device (which may be a personal computer, a server, a terminal device, or a network device, etc.) to execute the method according to embodiments of the present disclosure, specifically including:
displaying at least one other virtual character; determining a target virtual character from the other virtual character; displaying at least one available hit position on the target virtual character; determining a target hit position from the available hit position; controlling a master control virtual character to strike the target virtual character and triggering a hit effect corresponding to the target hit position.

In some embodiments, determining the target virtual character from other virtual characters includes: adjusting the position of a crosshair in response to an adjustment operation on the crosshair; and determining the target virtual character from other virtual characters according to the position of the crosshair.

In some embodiments, determining the target virtual character from the other virtual character includes: automatically determining, by a system, the target virtual character from other virtual character.

In some embodiments, displaying the at least one available hit position on the target virtual character includes: marking at least one available hit position on a model of the target virtual character.

In some embodiments, displaying the at least one available hit position on the target virtual character includes: displaying at least one piece of descriptive information for the at least one available hit position of the target virtual character, where the descriptive information includes description content for the available hit position.

In some embodiments, the descriptive information includes an auxiliary line for the available hit position, where the auxiliary line connects the description content and the available hit position on the target virtual character.

In some embodiments, the target virtual character includes a first part and a second part, and the at least one available hit position includes a first available hit position located at the first part and a second available hit position located at the second part.

In some embodiments, the target virtual character is a virtual human, and the first part is a head or a torso.

In some embodiments, determining the target hit position from the available hit position includes: determining the target hit position from the available hit position according to a received target key instruction, where a mapping relationship exists between a target key corresponding to the target key instruction and the target hit position.

In some embodiments, determining the target hit position from the available hit position includes: determining the target hit position from the available hit position according to a selection operation for the available hit position performed on a graphical user interface.

In some embodiments, the strike is a contact strike or a non-contact strike.

In some embodiments, types of the available hit position include a first-type position and a second-type position; and controlling the master control virtual character to strike the target virtual character includes: controlling the master control virtual character to strike the target hit position of the target virtual character; if the target hit position is the first-type position, then after the target hit position is struck, marking the target hit position as the second-type position; if the target hit position is the second-type position, then after the target hit position is struck, marking the target hit position as the first-type position.

In some embodiments, the available hit position is determined according to an orientation of the target virtual character relative to the master control virtual character.

In some embodiments, the available hit position is determined according to a type of the target virtual character.

In some embodiments, controlling the master control virtual character to strike the target virtual character and triggering the hit effect corresponding to the target hit position includes: controlling the master control virtual character to strike the target hit position of the target virtual character and triggering the hit effect corresponding to the target hit position.

In some embodiments, the information processing method includes: displaying an action connection line for the master control virtual character striking the target hit position, where the action connection line connects the master control virtual character and the target hit position.

In some embodiments, the information processing method includes: highlighting target descriptive information corresponding to the target hit position to distinguish the target descriptive information from the descriptive information corresponding to other available hit position.

In some embodiments, the information processing method includes: retaining a display of the target descriptive information, and canceling a display of the descriptive information corresponding to the other available hit position.

In an embodiment of the present disclosure, a computer-readable storage medium is further provided, on which a program product capable of implementing the above method of the present specification is stored. In some possible implementations, various aspects of the present disclosure may also be implemented in the form of a program product, which includes a program code. When the program product is run on a terminal device, the program code is used to enable the terminal device to execute the above information processing method of the present specification, specifically including:
displaying at least one other virtual character; determining a target virtual character from the other virtual character; displaying at least one available hit position on the target virtual character; determining a target hit position from the available hit position; controlling a master control virtual character to strike the target virtual character and triggering a hit effect corresponding to the target hit position.

In some embodiments, determining the target virtual character from other virtual characters includes: adjusting the position of a crosshair in response to an adjustment operation on the crosshair; and determining the target virtual character from other virtual characters according to the position of the crosshair.

In some embodiments, determining the target virtual character from the other virtual character includes: automatically determining, by a system, the target virtual character from other virtual character.

In some embodiments, displaying the at least one available hit position on the target virtual character includes: marking at least one available hit position on a model of the target virtual character.

In some embodiments, displaying the at least one available hit position on the target virtual character includes: displaying at least one piece of descriptive information for the at least one available hit position of the target virtual character, where the descriptive information includes description content for the available hit position.

In some embodiments, the descriptive information includes an auxiliary line for the available hit position, where the auxiliary line connects the description content and the available hit position on the target virtual character.

In some embodiments, the target virtual character includes a first part and a second part, and the at least one available hit position includes a first available hit position located at the first part and a second available hit position located at the second part.

In some embodiments, the target virtual character is a virtual human, and the first part is a head or a torso.

In some embodiments, determining the target hit position from the available hit position includes: determining the target hit position from the available hit position according to a received target key instruction, where a mapping relationship exists between a target key corresponding to the target key instruction and the target hit position.

In some embodiments, determining the target hit position from the available hit position includes: determining the target hit position from the available hit position according to a selection operation for the available hit position performed on a graphical user interface.

In some embodiments, the strike is a contact strike or a non-contact strike.

In some embodiments, types of the available hit position include a first-type position and a second-type position; and controlling the master control virtual character to strike the target virtual character includes: controlling the master control virtual character to strike the target hit position of the target virtual character; if the target hit position is the first-type position, then after the target hit position is struck, marking the target hit position as the second-type position; if the target hit position is the second-type position, then after the target hit position is struck, marking the target hit position as the first-type position.

In some embodiments, the available hit position is determined according to an orientation of the target virtual character relative to the master control virtual character.

In some embodiments, the available hit position is determined according to a type of the target virtual character.

In some embodiments, controlling the master control virtual character to strike the target virtual character and triggering the hit effect corresponding to the target hit position includes: controlling the master control virtual character to strike the target hit position of the target virtual character and triggering the hit effect corresponding to the target hit position.

In some embodiments, the information processing method includes: displaying an action connection line for the master control virtual character striking the target hit position, where the action connection line connects the master control virtual character and the target hit position.

In some embodiments, the information processing method includes: highlighting target descriptive information corresponding to the target hit position to distinguish the target descriptive information from the descriptive information corresponding to other available hit position.

In some embodiments, the information processing method includes: retaining a display of the target descriptive information, and canceling a display of the descriptive information corresponding to the other available hit position. The program product for implementing the above method according to the embodiments of the present disclosure can adopt a portable compact disk read-only memory (CD-ROM) and include program code, and can be run on a terminal device, such as a personal computer. However, the program product of the present disclosure is not limited to this. In this document, the readable storage medium can be any tangible medium containing or storing a program, which can be used by or in combination with an instruction execution system, an apparatus or a device.

In the information processing method, the electronic device, and the storage medium of the embodiments of the present application, at least one other virtual character is displayed; a target virtual character is determined from other virtual characters; at least one available hit position on the target virtual character is displayed; a target hit position is determined from the available hit position; and the master control virtual character is controlled to strike the target virtual character and the hit effect corresponding to the target hit position is triggered. In this way, the technical problems in the solutions of related art, such as the difficulty in aiming at the hit position and the low accuracy of selecting the hit position, can be at least partially solved.

A program product may take the form of any combination of one or more readable media. The readable medium may be a readable signal medium or a readable storage medium. The readable storage medium may be, for example, but not limited to, an electrical, magnetic, optical, electromagnetic, infrared, or semiconductor system, apparatus, or device, or any combination thereof. More specific examples (non-exhaustive list) of readable storage media include: an electrical connection with one or more conductors, a portable disk, a hard disk, a random access memory (RAM), a read only memory (ROM), an erasable programmable read-only memory (EPROM or flash memory), an optical fiber, a portable compact disk read-only memory (CD-ROM), an optical storage device, a magnetic storage device, or any suitable combination of the foregoing.

A computer readable signal medium may include a data signal carrying readable program codes in baseband or as part of a carrier wave. Such propagated data signal may take many forms, including but not limited to an electromagnetic signal, an optical signal, or any suitable combination of the foregoing. A readable signal medium may also be any readable medium other than a readable storage medium, and the readable medium may transmit, propagate, or transport a program for use by or in conjunction with an instruction execution system, apparatus, or device.

The program codes embodied on a readable medium may be transmitted using any appropriate medium, including but not limited to wireless, wireline, optical fiber cable, RF, etc., or any suitable combination of the foregoing.

The program codes for performing operations of the present disclosure may be written in any combination of one or more programming languages, including an object-oriented programming language-such as Java, C++, etc., as well as a conventional procedural programming language-such as “C” or similar programming language. The program code may be executed entirely on the user computing device, partially on the user device, as a stand-alone software package, partially on the user computing device and partially on a remote computing device, or entirely on a remote computing device or server. In the cases that a remote computing device is involved, the remote computing device may be connected to the user computing device through any type of network, including a local area network (LAN) or a wide area network (WAN), or may be connected to an external computing device (e.g., via the Internet provided by an Internet service provider).

In addition, the above-mentioned accompanying drawings are only schematic illustrations of the processes included in the method according to the embodiments of the present disclosure, and are not intended to be limiting. It is easy to understand that the processes shown in the above-mentioned drawings do not indicate or limit the time sequence of these processes. In addition, it is also easy to understand that these processes can be performed synchronously or asynchronously, for example, in multiple modules.

It should be noted that, although several modules or units of the device for action execution are mentioned in the above detailed description, such division is not mandatory. In fact, according to the embodiments of the present disclosure, the features and functions of two or more modules or units described above can be embodied in one module or unit. On the contrary, the features and functions of one module or unit described above can be further divided to be embodied by a plurality of modules or units.

Other embodiments of the present disclosure will be readily conceived by those skilled in the art upon consideration of the specification and practice of the invention disclosed herein. The present disclosure is intended to cover any variations, uses, or adaptations of the present disclosure that follow the general principles of the present disclosure and include common general knowledge or conventional technical means in the art that are not disclosed herein. The specification and examples are to be regarded as exemplary only, and the true scope and spirit of the present disclosure are indicated by the claims.

It should be understood that the present disclosure is not limited to the precise structures described above and shown in the drawings, and various modifications and changes can be made without departing from the scope thereof. The scope of the present disclosure is limited only by the appended claims.

1. An information processing method, comprising:
displaying at least one other virtual character;
determining a target virtual character from the other virtual character;
displaying at least one available hit position on the target virtual character;
determining a target hit position from the available hit position; and
controlling a master control virtual character to strike the target virtual character and triggering a hit effect corresponding to the target hit position.

2. The method according to claim 1, wherein determining the target virtual character from the other virtual character comprises:
in response to an adjustment operation on a crosshair, adjusting a position of the crosshair; and
determining the target virtual character from the other virtual character according to the position of the crosshair.

3. The method according to claim 1, wherein determining the target virtual character from the other virtual character comprises:
automatically determining, by a system, the target virtual character from the other virtual character.

4. The method according to claim 1, wherein displaying the at least one available hit position on the target virtual character comprises:
marking the at least one available hit position on a model of the target virtual character.

5. The method according to claim 1, wherein displaying the at least one available hit position on the target virtual character comprises:
displaying at least one piece of descriptive information for the at least one available hit position of the target virtual character, wherein the descriptive information comprises description content for the available hit position.

6. The method according to claim 5, wherein the descriptive information comprises an auxiliary line for the available hit position, wherein the auxiliary line connects the description content and the available hit position on the target virtual character.

7. The method according to claim 1, wherein the target virtual character comprises a first part and a second part, and the at least one available hit position comprises a first available hit position located at the first part and a second available hit position located at the second part.

8. The method according to claim 7, wherein the target virtual character is a virtual human, and the first part is a head or a torso.

9. The method according to claim 1, wherein determining the target hit position from the available hit position comprises:
determining the target hit position from the available hit position according to a received target key instruction, wherein a mapping relationship exists between a target key corresponding to the target key instruction and the target hit position.

10. The method according to claim 1, wherein determining the target hit position from the available hit position comprises:
determining the target hit position from the available hit position according to a selection operation performed on a graphical user interface for the available hit position.

11. The method according to claim 1, wherein the strike is a contact strike or a non-contact strike.

12. The method according to claim 1, wherein types of the available hit position comprise a first-type position and a second-type position; and controlling the master control virtual character to strike the target virtual character comprises:
controlling the master control virtual character to strike the target hit position of the target virtual character;
in a case that the target hit position is the first-type position, marking the target hit position as the second-type position after the target hit position is struck; and
in a case that the target hit position is the second-type position, marking the target hit position as the first-type position after the target hit position is struck.

13. The method according to claim 1, wherein the available hit position is determined according to an orientation of the target virtual character relative to the master control virtual character.

14. The method according to claim 1, wherein the available hit position is determined according to a type of the target virtual character.

15. The method according to claim 1, wherein controlling the master control virtual character to strike the target virtual character and triggering the hit effect corresponding to the target hit position comprises:
controlling the master control virtual character to strike the target hit position of the target virtual character, and triggering the hit effect corresponding to the target hit position.

16. The method according to claim 15, wherein the method comprises:
displaying an action connection line for the master control virtual character striking the target hit position, wherein the action connection line connects the master control virtual character and the target hit position.

17. The method according to claim 5, wherein the method comprises:
highlighting target descriptive information corresponding to the target hit position to distinguish the target descriptive information from descriptive information corresponding to the other available hit position.

18. The method according to claim 17, wherein the method comprises:
retaining a display of the target descriptive information, and canceling a display of the descriptive information corresponding to the other available hit position.

19. An electronic device, comprising:
a processor; and
a memory, configured to store executable instructions of the processor;
wherein the processor is configured to:
display at least one other virtual character;
determine a target virtual character from the other virtual character;
display at least one available hit position on the target virtual character;
determine a target hit position from the available hit position; and
control a master control virtual character to strike the target virtual character and trigger a hit effect corresponding to the target hit position.

20. A non-transitory computer-readable storage medium, having a computer program stored thereon, wherein the non-transitory computer program, when executed by a processor, implements:
displaying at least one other virtual character;
determining a target virtual character from the other virtual character;
displaying at least one available hit position on the target virtual character;
determining a target hit position from the available hit position; and
controlling a master control virtual character to strike the target virtual character and triggering a hit effect corresponding to the target hit position.
